(19) United States
(12) Patent Application Publication
(10) Pub. No.: US 2008/0036837 A1
(43) Pub. Date: Feb. 14, 2008

(54) Ink Tank with Features to Reduce Undesirable Bubbling

(76) Inventors: Trevor Daniel Gray, Versailles, KY (US); David Emerson, Lexington, KY (US); Angela Lyan Hudson, Lexington, KY (US); Ganesh Vinayak Phatak, Lexington, KY (US); Bhaskar Ramakrishnan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,827

(22) Filed: Jun. 30, 2006

(51) Int. Cl. B41J 2/19

(52) U.S. Cl. 347/92

(57) ABSTRACT

A removable ink tank includes a floor including an ink output port. A free ink chamber is located over the floor. A suspended ink chamber is located over the floor and around the ink output port. The suspended ink chamber is separated from the free ink chamber by a divider wall. The divider wall has an ink communication port located near the floor to facilitate fluid communication between the free ink chamber and the suspended ink chamber. A frame is formed around the ink communication port. The frame protrudes outwardly into the suspended ink chamber to ensure a good seal with the ink suspension member.

### FIELD OF THE INVENTION

The present invention relates to an ink tank, and, more particularly, to an ink tank with features to reduce undesirable air paths to in turn reduce undesirable bubbling.

### BACKGROUND OF THE INVENTION

An imaging apparatus, such as an ink jet printer, forms an image on a print medium, such as paper, by applying ink to the print medium. The ink may be contained in one or more replaceable supply cartridges. Examples of such replaceable supply cartridges include a replaceable ink tank and an ink jet printhead cartridge. An ink jet printhead cartridge, for example, includes both an ink tank and an ink jet micro-fluid ejection device. In contrast, a replaceable ink tank does not include the micro-fluid ejection device, but rather, the micro-fluid ejection device forms part of a printhead assembly that is separately attached to the printhead carrier.

One such ink jet printer mounts a plurality of ink tanks, with each ink tank containing a supply of a particular color of ink, e.g., black, cyan, magenta, and yellow. Each ink tank is mounted to a micro-fluid ejection device that is separately mounted to the printhead carrier, and is commonly referred to as an on-carrier ink tank system. In an on-carrier ink tank system, the ink is transferred from the ink tank to the micro-fluid ejection device through as series of fluid interfaces, e.g., a felt ink retaining member located in the ink tank and a wick located on the printhead assembly.

A typical ink tank includes a free ink chamber separated from a felt chamber by a dividing wall. The felt chamber has inserted therein the felt ink retaining member. The divider wall between the free ink chamber and the felt chamber has an ink communication port, sometimes referred to in the art as a “bubbler”, to allow transfer of air and ink between the two chambers. The term “bubbling” refers to the process of air and liquid exchange through the communication port, aka “bubbler”. Air enters the free ink chamber, which in turn allows ink from the free ink chamber to move into the felt chamber. The ink delivery pressure to the printhead assembly during the bubbling phase of ink delivery from the tank depends, among other things, on two factors: 1) Air flow resistance from the vented lid, through the felt, and to the communication port; and 2) Ink flow resistance from the free ink chamber, through the communication port, and through the felt to the wick on the printhead assembly.

The ink tank is typically molded from polypropylene. A lifter is used in a mold to produce the bubbler feature in the divider wall of the ink tank. Because of tooling tolerances the lifter is rarely perfectly flush with the floor, and as a result the lifter often leaves a molded mark in the form of a recess in the bottom floor of the ink tank in the felt chamber. The recess lines up with the edges of the bubbler. When the ink tank is filled with ink, ink from the free ink chamber pools underneath the felt ink retaining member in the recessed molded mark. Thus, essentially, the path from the wick of the printhead assembly to the free ink chamber is shortened by the recess. The bubbling pressure is partially dependant upon the length of felt through which the ink must travel before reaching the wick, since ink flow resistance increases as length increases, and vice-versa. Since the path length is reduced by the presence of the lifter recess, bubbling pressure can be reduced undesirably.

The wick/felt interference varies due to the tolerance stack up in the printhead assembly, ink tank, and the wick coupled to the printhead assembly. At the higher ends of interference, it may be possible to lift the ink retaining member off the floor of the felt chamber. The bubbling pressure may be reduced if the felt has lifted all the way to the recess formed in the floor adjacent to the bubbler. In this scenario, an air path exists from the wick opening at the ink output port formed in the floor all the way to the recess. The flow resistance for this air path is much lower than through the felt, so bubbling pressures are much lower than they should be. This failure mode is called “bottom bubbling”, since the air path to the free ink chamber comes from underneath the bottom felt rather than through the felt from the vent on the ink tank lid. Furthermore, if the lift-off is large enough, the backpressure in the free ink chamber created by the felt is relieved. The premature bubbling will cause the felt to be saturated and reduce any backpressure capability. The remaining free ink will then “drool” out the snout even at normal atmospheric operating pressure.

Also, anther failure mode referred to as “side bubbling” may occur when an air path between the divider wall and felt is formed and connects to the bubbler. Again, low bubbling pressures can result due to the reduced resistance in the air path.

### SUMMARY OF THE INVENTION

The present invention provides ink tank with features to reduce undesirable bubbling.

The invention, in one form thereof, is directed to a removable ink tank configured to be mounted to a printhead assembly installed on an imaging apparatus. The removable ink tank includes a floor including an ink output port. A free ink chamber is located over the floor. A suspended ink chamber is located over the floor and around the ink output port. The suspended ink chamber is separated from the free ink chamber by a divider wall. The divider wall has an ink communication port located near the floor to facilitate fluid communication between the free ink chamber and the suspended ink chamber. A frame is formed around the ink communication port. The frame protrudes outwardly into the suspended ink chamber.

The invention, in another form thereof, is directed to an imaging apparatus. The imaging apparatus includes a print engine including a printhead carrier. A printhead assembly is configured to be mounted to the printhead carrier. A removable ink tank is configured to be mounted to the printhead assembly. The removable ink tank includes a floor including an ink output port in fluid communication with the printhead assembly. A free ink chamber is located over the floor. A suspended ink chamber is located over the floor and around the ink output port. The suspended ink chamber is separated from the free ink chamber by a divider wall. The divider wall has an ink communication port located near the floor to facilitate fluid communication between the free ink chamber and the suspended ink chamber. A frame is formed around the ink communication port. The frame protrudes outwardly into the suspended ink chamber.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a perspective view of the printhead carrier of FIG. 1, with the printhead assembly and ink tanks uninstalled.

FIG. 3 is a sectional view of one of the removable ink tanks of FIG. 2 taken along line 3-3, with the ink tank uninstalled.

FIG. 4 is a sectional view of the removable ink tank of FIG. 2 referenced in the description of FIG. 3 taken along line 4-4.

FIG. 5 is a top view of the removable ink tank of FIG. 2 referenced in the description of FIG. 3, with the lid and ink suspension bodies removed to expose the floor features.

FIG. 6 is a sectional view of the removable ink tank of FIG. 4 taken along line 6-6, with the lower ink suspension body installed.

FIG. 7 is a sectional view of the removable ink tank of FIG. 4 taken along line 7-7, with the lower ink suspension body installed.

### DETAILED DESCRIPTION OF THE INVENTION

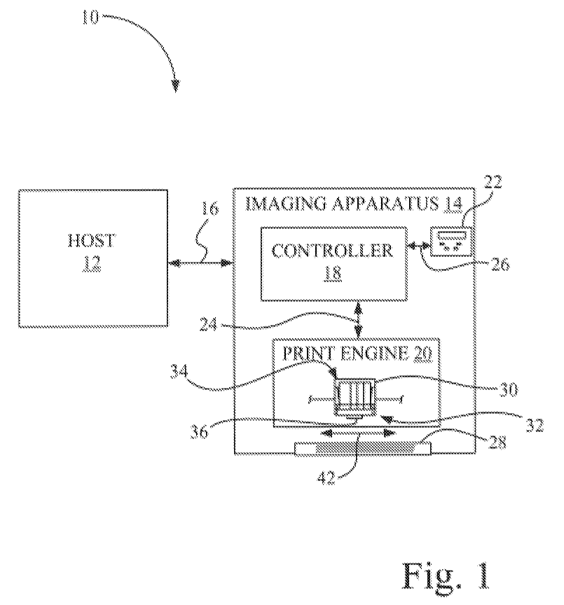

Referring to FIG. 1, there is shown a diagrammatic depiction of an imaging system 10 embodying the present invention. Imaging system 10 may include a host 12 and an imaging apparatus 14. Imaging apparatus 14 communicates with host 12 via a communications link 16. Communications link 16 may be established by a direct cable connection, wireless connection or by a network connection such as for example an Ethernet local area network (LAN).

Alternatively, imaging apparatus 14 may be a standalone unit that is not communicatively linked to a host, such as host 12. For example, imaging apparatus 14 may take the form of an all-in-one, i.e., multifunction, machine that includes standalone copying and facsimile capabilities, in addition to optionally serving as a printer when attached to a host, such as host 12.

Host 12 may be, for example, a personal computer including an input/output (I/O) device, such as keyboard and display monitor. Host 12 further includes a processor, input/output (I/O) interfaces, memory, such as RAM, ROM, NVRAM, and a mass data storage device, such as a hard drive, CD-ROM and/or DVD units. During operation, host 12 may include in its memory a software program including program instructions that function as an imaging driver, e.g., printer driver software, for imaging apparatus 14. Alternatively, the imaging driver may be incorporated, in whole or in part, in imaging apparatus 14.

In the embodiment of FIG. 1, imaging apparatus 14 includes a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communication link 26. Communications link 24 and 26 may be established, for example, by using standard electrical cabling or bus structures, or by wireless connection.

Print engine 20 may be, for example, an ink jet print engine configured for forming an image on a sheet of print media 28, such as a sheet of paper, transparency or fabric. Print engine 20 may include, for example, a reciprocating printhead carrier 30.

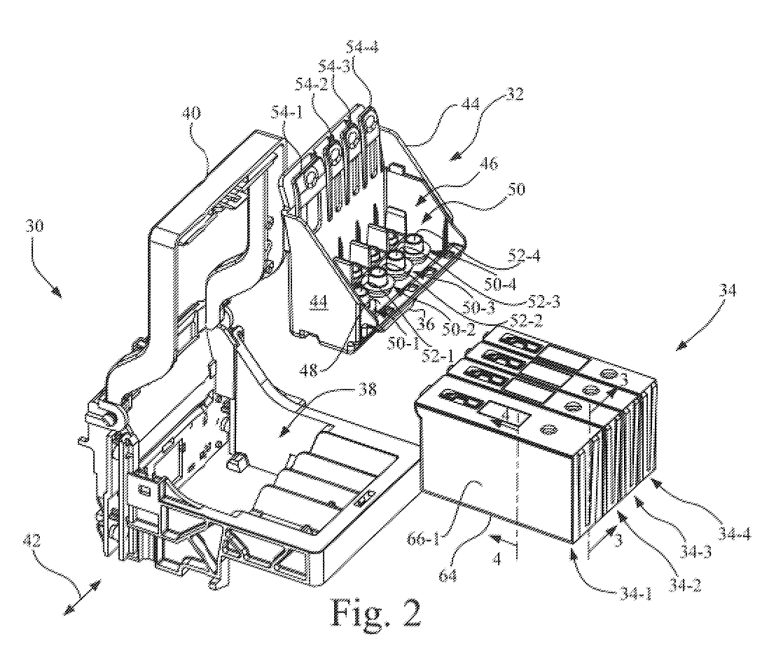

FIG. 2 shows in a perspective view printhead carrier 30, with a printhead assembly 32 and a plurality of removable ink tanks 34 in an uninstalled state. Printhead carrier 30 is mechanically and electrically configured to mount and carry at least one printhead assembly 32 that includes at least one ink jet micro-fluid ejection device 36. Printhead assembly 32 is mounted into position to printhead carrier 30 by inserting printhead assembly 32 into a cavity 38 in printhead carrier 30, and is latched in position by a mounting lever 40. Printhead carrier 30 transports printhead assembly 32, and in turn ink jet micro-fluid ejection device 36, in a reciprocating manner in a bi-directional main scan direction, i.e., axis, 42 over an image surface of the sheet of print media 28 during a printing operation.

Printhead assembly 32 is configured to mount and carry the plurality of removable ink tanks 34, and to facilitate an ink transfer from one or more of the plurality of removable ink tanks 34 to micro-fluid ejection device 36. The plurality of removable ink tanks 34 may be made, for example, from plastic. The plurality of ink tanks 34 are individually identified as ink tanks 34-1, 34-2, 34-3 and 34-4, and may include a monochrome ink tank containing black ink, and three color ink tanks containing cyan, magenta, and yellow inks. Micro-fluid ejection device 36 may include an ink jet nozzle array for each color of ink.

Printhead assembly 32 includes a printhead body 44 and a filter cap 46. Micro-fluid ejection device 36 is attached to a snout portion of printhead body 44. Filter cap 46 is attached to printhead body 44 via a hermetic seal, such as by welding or adhesive attachment. Filter cap 46 has a filter cap body 48 configured with a plurality of ink receiving devices 50, individually identified as ink receiving device 50-1, ink receiving device 50-2, ink receiving device 50-3, and ink receiving device 50-4. Each ink receiving device 50-1, 50-2, 50-3, and 50-4 includes a respective wick 52-1, 52-2, 52-3, and 52-4 that operably engages and facilitates fluid communication with the respective ink output ports of ink tanks 34-1, 34-2, 34-3 and 34-4, respectively. Each of wicks 52-1, 52-2, 52-3, and 52-4 may be constructed from a porous material, such as for example, from a porous felt material or a porous foam material. Ink tanks 34-1, 34-2, 34-3 and 34-4 are individually mounted to printhead assembly 32 via individual latches 54-1, 54-2, 54-3 and 54-4.

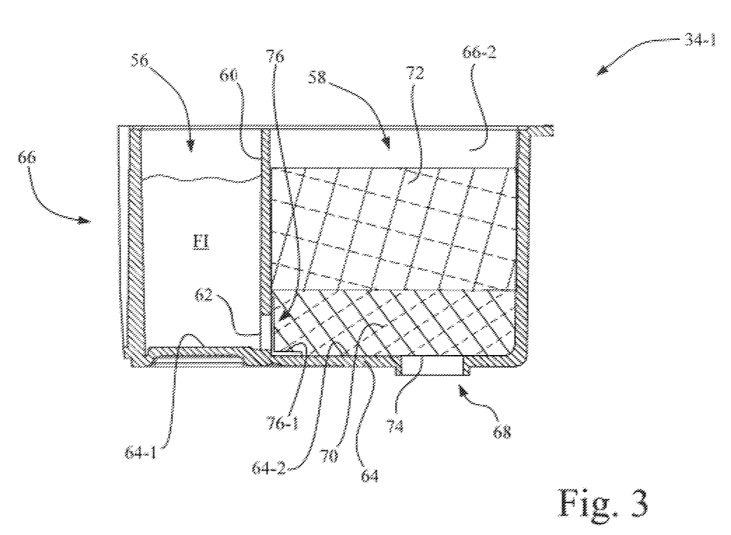

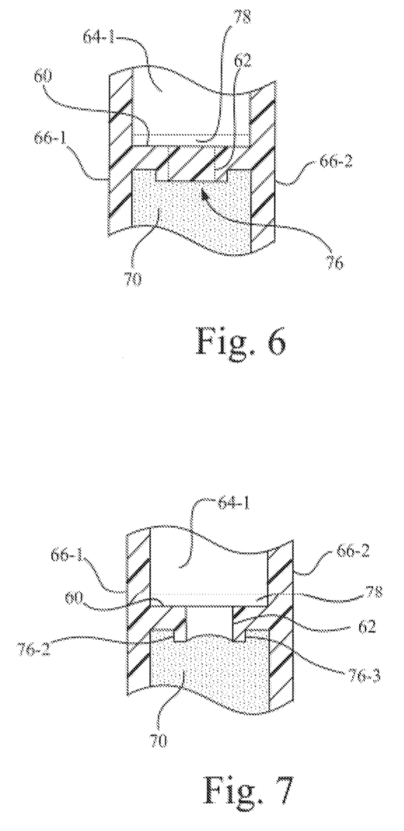

FIGS. 3-7 are various views of one of the removable ink tanks 34, using ink tank 34-1 as an example. Each of removable ink tanks 34 are similar in design, varying only in size in the present embodiment. Accordingly, for convenience and ease of discussion, the following description will specifically reference ink tank 34-1, but those skilled in the art will recognize that the description may be applied equally to each of ink tank 34-2, ink tank 34-3, and ink tank 34-4.

Ink tank 34-1, includes a free ink chamber 56 and a suspended ink chamber 58. Free ink chamber 56 includes a free-flowing supply of ink F1, and is positioned adjacent to suspended ink chamber 58. Free ink chamber 56 is separated from suspended ink chamber 58 by a divider wall 60. Divider wall 60 has an ink communication port, i.e., bubbler, 62 to provide fluid communication between free ink chamber 56 and suspended ink chamber 58.

Ink tank 34-1 has a floor 64, and a plurality of side walls 66 extending upwardly away from floor 64. Floor 64 includes a first floor portion 64-1 and a second floor portion 64-2. Free ink chamber 56 is located over first floor portion 64-1 of floor 64. Suspended ink chamber 58 is located over second floor portion 64-2 of floor 64 around an ink output port 68 formed through second floor portion 64-2 of floor 64. Ink output port 68 facilitates fluid communication with printhead assembly 32 when ink tank 34-1 is installed on printhead assembly 32. Suspended ink chamber 58 contains an ink suspension material, such as a felt material or a foam material, as will be described in more detail below, to provide a restriction to prevent a free-flow of ink through a suspended ink chamber 58 to ink output port 68 and produce a negative pressure.

The plurality of side walls 66 include, for example, a first side wall 66-1 and a second side 66-2. Side wall 66-2 is separated from side wall 66-1, with divider wall 60 being interposed between and connected to each of side wall 66-1 and side wall 66-2. Ink communication port, i.e., bubbler, 62 is located in a lower portion of divider wall 60 near floor 64 to provide fluid communication between the free ink chamber 56 and suspended ink chamber 58.

Positioned in suspended ink chamber 58 adjacent to floor 64 is a lower ink suspension body 70. An upper ink suspension body 72 is positioned in suspended ink chamber 58 adjacent to and above lower ink suspension body 70. Each of lower ink suspension body 70 and upper ink suspension body 72 may be constructed from a porous material, such as for example, from a porous felt material or a porous foam material. Lower ink suspension body 70 has a porous ink transfer surface 74 positioned above ink output port 68, which is engaged and deflected by ink receiving device 50-1 and its associated wick 52-1 when ink tank 34-1 is installed in printhead assembly 32.

In accordance with an embodiment of the present invention, a frame 76 is formed around ink communication port 62, with frame 76 protruding outwardly into suspended ink chamber 58. Lower ink suspension body 70 is positioned in suspended ink chamber 58 to engage frame 76 around ink communication port 62. The engagement of frame 76 with lower ink suspension body 70 reduces the possibility of undesirable bubbling, e.g., bottom bubbling or side bubbling.

All or a portion of frame 76 may be formed, for example, by the lifter used to produce ink communication port, i.e., bubbler, 62 in divider wall 60 of ink tank 34-1 during molding. Alternatively, all or a portion of frame 76 may be defined by the mold used in molding ink tank 34-1.

In the present embodiment, frame 76 may include a first frame portion 76-1, a second frame portion 76-2, a third frame portion 76-3, and a fourth frame portion 76-4.

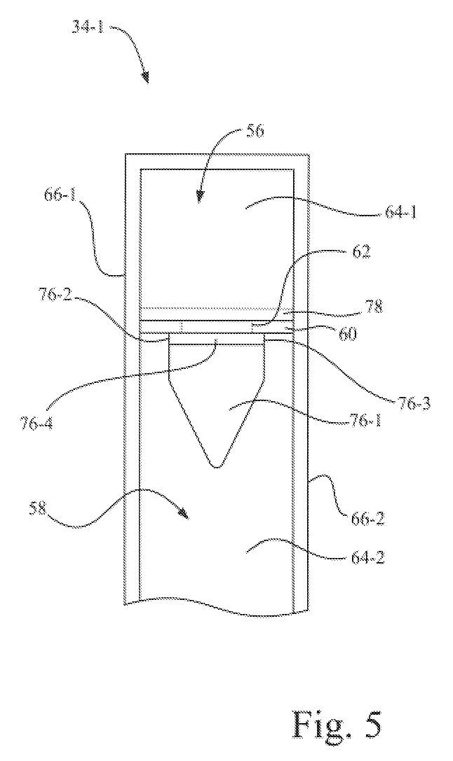

Referring particularly to FIGS. 3-5, first frame portion 76-1 of frame 76 extends upwardly from second floor portion 64-2 of floor 64 in suspended ink chamber 58 to provide the desired protrusion for contact with the lower surface 74 of lower ink suspension body 70 in a floor region adjacent to ink communication port 62. In the present embodiment, as shown in FIG. 5 for example, first frame portion 76-1 has a trapezoidal shape when viewed downwardly toward second floor portion 64-2 of floor 64 from above. Those skilled in the art will recognize that other shapes, such as triangular, rectangular or semicircular, may be used, if desired, to provide the desired protrusion structure.

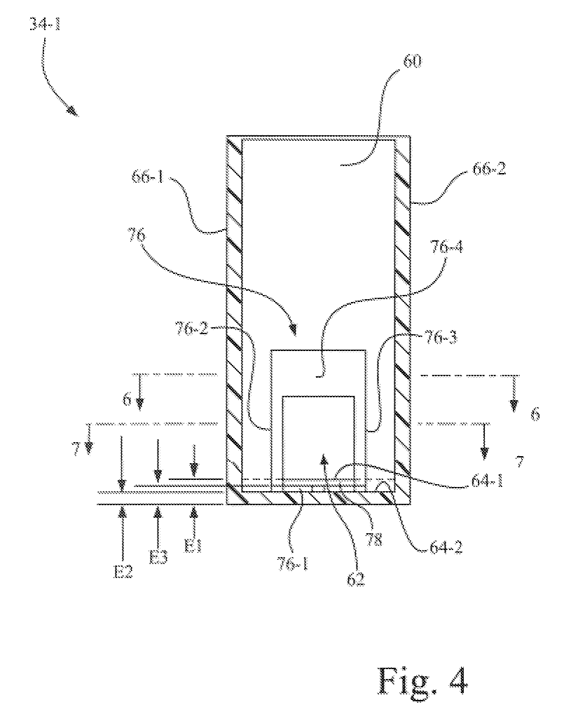

As can be best seen in FIG. 4, a first elevation E1 of first floor portion 64-1 is higher than a second elevation E2 of second floor portion 64-2, and a third elevation E3 of first frame portion 76-1 is at an elevation intermediate to first elevation E1 and second elevation E2. Referring also to FIGS. 5 and 7, a transition feature 78, which may be in the form of stair steps having one or more radii at transition edges, transitions downwardly from first elevation E1 of first floor portion 64-1 in free ink chamber 56 to third elevation E3 of first frame portion 76-1 in suspended ink chamber 58.

As best shown in FIG. 4, each of second frame portion 76-2 and third frame portion 76-3 extends upwardly from first frame portion 76-1, and thus extends upwardly from second floor portion 64-2. Ink communication port 62 is located between second frame portion 76-2 and third frame portion 76-3. Fourth frame portion 76-4 is located over ink communication port 62 and bridges between second frame portion 76-2 and said third frame portion 76-3. Accordingly, in the present embodiment, ink communication port 62 also is located between fourth frame portion 76-4 and first frame portion 76-1, with frame 76 completely surrounding ink communication port 62 in divider wall 60.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A removable ink tank configured to be mounted to a printhead assembly installed on an imaging apparatus, comprising:
a floor including an ink output port;
a free ink chamber located over said floor;
a suspended ink chamber located over said floor and around said ink output port, said suspended ink chamber being separated from said free ink chamber by a divider wall, said divider wall having an ink communication port located near said floor to facilitate fluid communication between said free ink chamber and said suspended ink chamber; and
a frame formed around said ink communication port, said frame protruding outwardly into said suspended ink chamber.

2. The removable ink tank of claim 1, further comprising an ink suspension body positioned in said suspended ink chamber to engage said frame around said ink communication port, said ink suspension body being constructed from one of a porous felt material, a porous foam material, or any other negative pressure producing material.

3. The removable ink tank of claim 1, wherein said floor has a first floor portion location in said free ink chamber and a second floor portion located in said suspended ink chamber, and wherein a first frame portion of said frame extends upwardly from said second floor portion of said floor.

4. The removable ink tank of claim 3, wherein said first frame portion of said frame has a trapezoidal shape when viewed downwardly toward said floor.

5. The removable ink tank of claim 3, wherein a first elevation of said first floor portion is higher than a second elevation of said second floor portion, and wherein a third elevation of said first frame portion is intermediate to said first elevation and said second elevation.

6. The removable ink tank of claim 1, said frame including:
a first frame portion extending upwardly from said second floor portion;
a second frame portion extending upwardly from said first frame portion; and
a third frame portion extending upwardly from said first frame portion, with said ink communication port being located between said second frame portion and said third frame portion.

7. The removable ink tank of claim 6, said frame including a fourth frame portion bridging between said second frame portion and said third frame portion, with said ink communication port being located between said fourth frame portion and said first frame portion.

8. An imaging apparatus, comprising:
a print engine including a printhead carrier;
a printhead assembly configured to be mounted to said printhead carrier; and
a removable ink tank configured to be mounted to said printhead assembly, said removable ink tank including:
a floor including an ink output port in fluid communication with said printhead assembly;
a free ink chamber located over said floor;
a suspended ink chamber located over said floor and around said ink output port, said suspended ink chamber being separated from said free ink chamber by a divider wall, said divider wall having an ink communication port located near said floor to facilitate fluid communication between said free ink chamber and said suspended ink chamber; and
a frame formed around said ink communication port, said frame protruding outwardly into said suspended ink chamber.

9. The imaging apparatus of claim 8, further comprising an ink suspension body positioned in said suspended ink chamber to engage said frame around said ink communication port, said ink suspension body being constructed from one of a porous felt material, a porous foam material, or any other negative pressure producing material.

10. The imaging apparatus of claim 8, wherein said floor has a first floor portion located in said free ink chamber and a second floor portion located in said suspended ink chamber, and wherein a first frame portion of said frame extends upwardly from said second floor portion of said floor.

11. The imaging apparatus of claim 10, wherein said first frame portion of said frame has a trapezoidal shape when viewed downwardly toward said floor.

12. The imaging apparatus of claim 10, wherein a first elevation of said first floor portion is higher than a second elevation of said second floor portion, and wherein a third elevation of said first frame portion is intermediate to said first elevation and said second elevation.

13. The imaging apparatus of claim 8, said frame including:
a first frame portion extending upwardly from said second floor portion;
a second frame portion extending upwardly from said first frame portion; and
a third frame portion extending upwardly from said first frame portion, with said ink communication port being located between said second frame portion and said third frame portion.

14. The imaging apparatus of claim 13, said frame including a fourth frame portion bridging between said second frame portion and said third frame portion, with said ink communication port being located between said fourth frame portion and said first frame portion.

15. The imaging apparatus of claim 8 wherein said removable ink tank is one of a plurality of removable ink tanks configured to be mounted to said printhead assembly.
